(19) United States
(12) Patent Application Publication
(10) Pub. No.: US 2026/0167291 A1
(43) Pub. Date: Jun. 18, 2026

(54) Rear Bodywork for a Single-Track Motor Vehicle, and Single-Track Motor Vehicle Having the Rear Bodywork

(71) Applicant: Bayerische Motoren Werke Aktiengesellschaft, Muenchen (DE)

(72) Inventors: Andreas MARTIN, Wolfratshausen (DE); Mathias MUEHLMANN, Olching (DE)

(21) Appl. No.: 18/846,315

(22) PCT Filed: May 24, 2023
(86) PCT No.: PCT/EP2023/063861

§ 371 Date: Sep. 12, 2024

(30) Foreign Application Priority Data
Jun. 14, 2022 (DE) 10 2022 114 927.7

(51) Int. Cl. B62J 17/10

(52) U.S. Cl. CPC B62J 17/10

(57) ABSTRACT

Rear bodywork for a single-track motor vehicle (e.g. a motorcycle) includes a longitudinal extent and at least one recess, wherein the at least one recess is designed such that a flow channel for an air flow is formed. A single-track vehicle includes a rear wheel and the rear bodywork, wherein the corresponding flow channel is designed such that the air flow is able to be conducted into a region between the rear wheel and the rear bodywork.

### BACKGROUND AND SUMMARY

This disclosure relates to a rear bodywork for a single-track motor vehicle (e.g, a motorcycle) and a single-track motor vehicle having a rear wheel and the rear bodywork.

A rear bodywork of a single-track motor vehicle is generally configured in such a manner that, in addition to the design requirements, the components are also encased inside the vehicle. In this instance, a specific structural width is produced, which is intended to block a direct spraying of dirt from the mostly very freestanding rear wheel, but which also increases a reduced pressure in the region around and above the rear wheel.

Furthermore, with single-track motor vehicles when travelling in rain and/or when travelling on dirty roads a cloud of spray is produced in the rear region and is stirred up by the rear wheel and consequently makes the rear end and in particular the lower side of the thigh of the driver dirty. This effect is amplified as a result of the reduced pressure in this region since during travel the water which is stirred up is drawn into the reduced pressure regions.

An object of the present disclosure is therefore to provide a rear bodywork for a single-track motor vehicle which at least reduces or eliminates the reduced pressure in the region around and above the rear wheel.

According to the disclosure, a rear bodywork for a single-track motor vehicle having a longitudinal extent and at least one recess is proposed. In this instance, the at least one recess is configured in such a manner that a flow channel for an air flow is formed. The advantage of this is that a targeted air flow can be produced by way of the rear bodywork.

In an advantageous variant, there is provision for the recess to extend at least partially along the longitudinal extent of the rear bodywork. In this manner, the air flow can be directed along the longitudinal extent of the rear bodywork.

Preferably, the rear bodywork is configured in such a manner that an additional recess is further formed, wherein the additional recess is configured in such a manner that another flow channel is formed for an air flow. Furthermore, an embodiment is advantageous in which the additional recess extends at least partially along the longitudinal extent of the rear bodywork.

In a preferred embodiment of the disclosure, the recesses are arranged diametrically opposed in each case in an end region of a transverse extent of the rear bodywork. A targeted air flow can thereby be generated at both sides of the rear bodywork, whereby, on the one hand, an increased volume flow of the air flow can be directed and, on the other hand, the aerodynamic properties of the single-track motor vehicle are optimized.

In another advantageous variant, there is provision according to the disclosure for there to be formed in the at least one recess at least one air guiding element which extends at least partially along the recess. In this instance, it is advantageous that the at least one air guiding element optimizes the flow in the flow channel. Furthermore, the at least one air guiding element forms a separator which prevents the driver's thigh from being sprayed directly with dirt via the flow channel. In an alternative variant, the at least one air guiding element extends beyond the recess.

It is further advantageous for there to be formed a large number of air guiding elements which are arranged in parallel and which are arranged in the corresponding recess with uniform spacing from each other. In an exemplary embodiment of the disclosure, there is provision for the at least one air guiding element to extend in a substantially rectilinear manner. In this manner, the function as a separator is improved since the flow channel is better covered with respect to spraying of dirt via the flow channel. Alternatively, the air guiding elements are arranged at different angles with respect to each other.

In an advantageous variant, there is provision for an angled projection to be formed on at least one end of a longitudinal extent of the at least one air guiding element. The advantage of this is that the angled projection better prevents spraying of dirt and the corresponding dirt drips off on the projection.

The rear bodywork according to the disclosure is configured in one variant in such a manner that the at least one air guiding element is arranged at a predetermined angle with respect to the longitudinal extent of the rear bodywork. The at least one air guiding element is thereby orientated in an optimum manner with respect to spraying of dirt.

In an alternative embodiment of the present rear bodywork, there is further provision for the at least one air guiding element (6) to have a decreasing cross section. In this instance, it is advantageous for the flow properties of the air guiding element to be improved.

In another advantageous variant, there is provision for at least one air-permeable grid to be arranged on or in the corresponding recess, in particular in front of the at least one air guiding element in the flow direction of the air flow. Alternatively to the grid, a perforated structure is arranged in the recess or at an opening of the recess. A protection against spraying of dirt, in particular large droplets of dirt, is thereby optimized.

In one variant of the disclosure, there is provision for at least one subsequent guiding element for the air flow to be arranged on the corresponding flow channel. In this manner, an orientation of the targeted air flow is improved.

According to the disclosure a single-track motor vehicle having a rear wheel and a rear bodywork according to the present disclosure is proposed. In this instance, the corresponding flow channel is configured in such a manner that the air flow can be directed into a region between the rear wheel and the rear bodywork. It is advantageous that a targeted air flow is directed into the reduced pressure region between the rear bodywork and rear wheel in order to reduce this. The protection from spraying of dirt is thereby improved. In particular, the at least one air guiding element is arranged at such a predetermined angle with respect to the longitudinal extent of the rear bodywork that a spray protection for dirt and/or water thrown off the rear wheel or rain on the road is optimized as a result of the reduction of the reduced pressure.

The features disclosed above can be freely combined as long as technically possible and they are not mutually contradictory.

### BRIEF DESCRIPTION OF THE DRAWINGS

Other advantageous further developments of the disclosure are set out in greater detail below together with the description of the preferred embodiment of the disclosure with reference to the Figures.

FIG. 1 shows a perspective view of a single-track motor vehicle having a rear wheel and a rear bodywork;

FIG. 2 shows a perspective view of the rear bodywork;

FIG. 3a shows a front view of the rear bodywork;

FIG. 3b shows a rear view of the rear bodywork and

FIG. 4 shows a sectioned view of the rear bodywork.

The Figures are by way of example schematic. The same reference numerals in the Figures indicate identical functional and/or structural features.

### DETAILED DESCRIPTION OF THE DRAWINGS

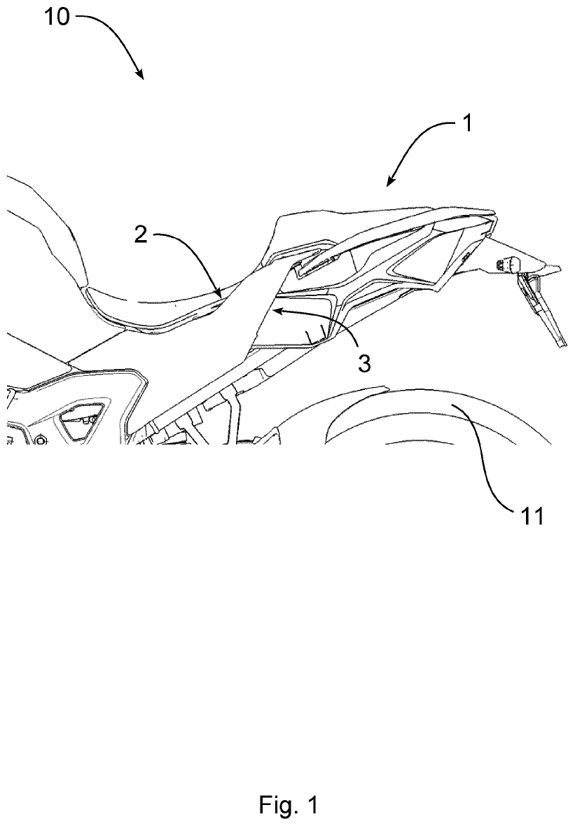

FIG. 1 shows a perspective view of a single-track motor vehicle having a rear wheel and a rear bodywork. The single-track motor vehicle 10 comprises a rear wheel 11 and a rear bodywork 1 having a recess 2 which is configured in such a manner that a flow channel 3 for an air flow is formed. The corresponding flow channel 3 is configured in such a manner that the air flow can be directed into a region between the rear wheel 11 and the rear bodywork 1.

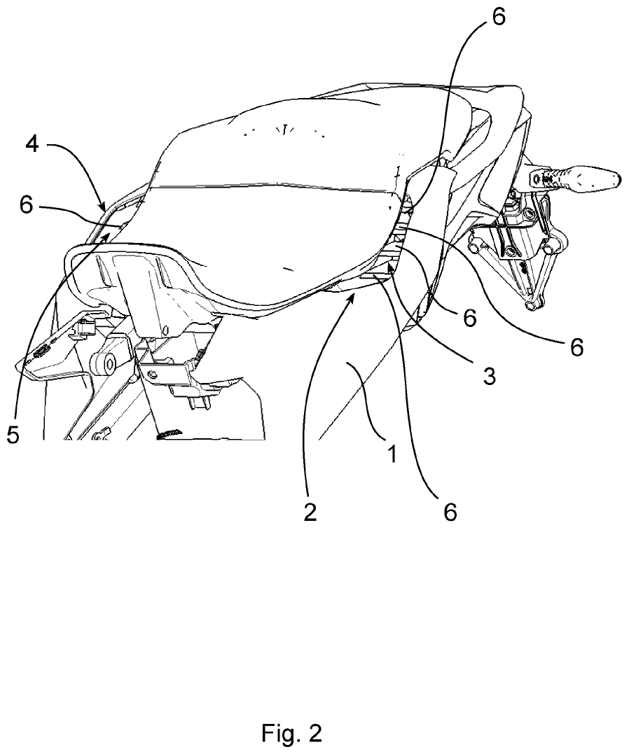

FIG. 2 shows a perspective view of the rear bodywork 1 illustrated in FIG. 1. The rear bodywork 1 having a longitudinal extent comprises a recess 2 which is configured in such a manner that a flow channel 3 is formed for an air flow. The recess 2 extends at least partially along the longitudinal extent of the rear bodywork 1. Furthermore, an additional recess 4 is configured in such a manner that an additional flow channel 5 is formed for an air flow. The additional recess 4 extends at least partially along the longitudinal extent of the rear bodywork 1. Furthermore, four air guiding elements 6 are arranged in the respective recess 2, 4.

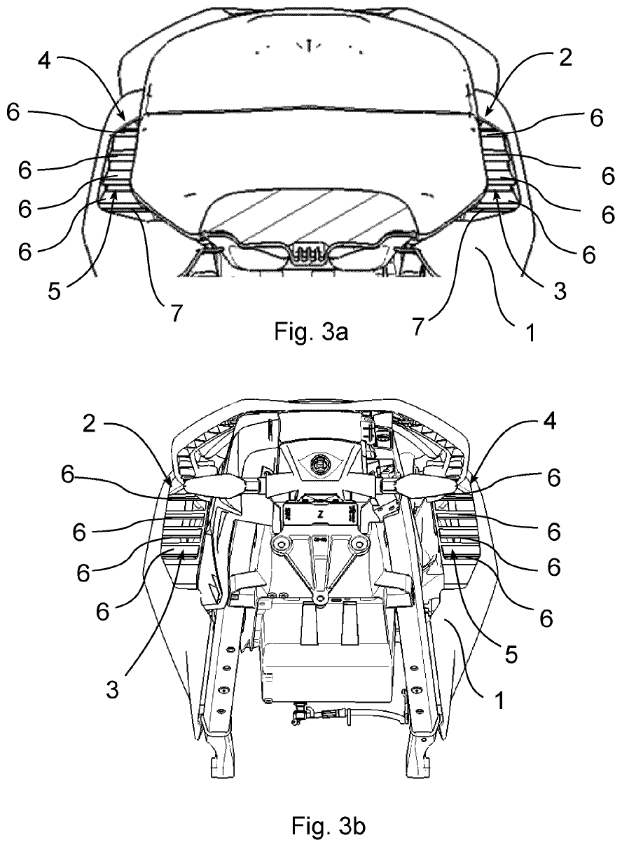

FIG. 3a shows a front view of the rear bodywork 1 and FIG. 3b shows a rear view of the rear bodywork 1. In this instance, the recesses 2, 4 are in each case arranged diametrically opposed in an end region of a transverse extent of the rear bodywork 1. Furthermore, there are formed four air guiding elements 6 which are arranged in parallel and which are arranged with uniform spacing from each other in the corresponding recess 2, 4. The respective air guiding element 6 extends partially along the recess. Furthermore, the air guiding elements 6 are arranged at a predetermined angle with respect to the longitudinal extent of the rear bodywork 1 and the rear wheel 11. At one end of a longitudinal extent of the respective air guiding element 6, an angled projection 7 is formed.

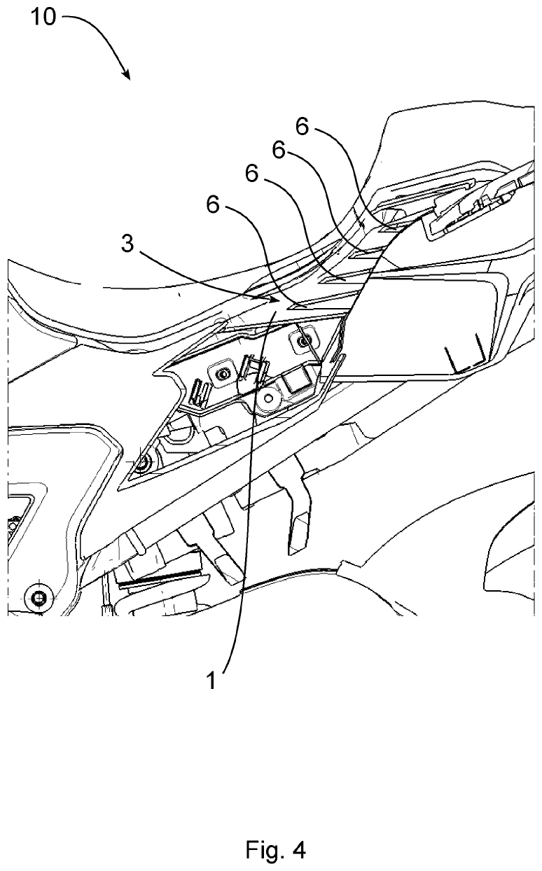

FIG. 4 shows a sectioned view of the rear bodywork 1 illustrated in the above Figures. The air guiding elements 6 have a decreasing cross section. Furthermore, the air guiding elements 6 extend in a substantially rectilinear manner. The air guiding elements 6 may be configured and/or formed as baffles.

The disclosure is not limited in terms of its configuration to the preferred exemplary embodiments set out above. Instead, a number of variants which make use of the illustrated solution, even with embodiments which are in principle of a different type are conceivable.

1.-14. (canceled)

15. A rear bodywork for a single-track motor vehicle comprises:
a longitudinal extent and at least one recess, wherein the at least one recess is configured in such a manner that a flow channel for an air flow is formed.

16. The rear bodywork according to claim 15, wherein the recess extends at least partially along the longitudinal extent of the rear bodywork.

17. The rear bodywork according to claim 15, wherein an additional recess is further formed, wherein the additional recess is configured in such a manner that another flow channel is formed for an air flow.

18. The rear bodywork according to claim 17, wherein the additional recess extends at least partially along the longitudinal extent of the rear bodywork.

19. The rear bodywork according to claim 18, wherein the recesses are arranged diametrically opposed in each case in an end region of a transverse extent of the rear bodywork.

20. The rear bodywork according to claim 15, wherein there is formed in the at least one recess at least one air guiding element which extends at least partially along the recess.

21. The rear bodywork according to claim 20, wherein there are formed a plurality of air guiding elements which are arranged in parallel and which are arranged in the corresponding recess with uniform spacing from each other.

22. The rear bodywork according to claim 20, wherein the at least one air guiding element extends in a substantially rectilinear manner.

23. The rear bodywork according to claim 20, wherein an angled projection is formed on at least one end of a longitudinal extent of the at least one air guiding element.

24. The rear bodywork according to claim 20, wherein the at least one air guiding element is arranged at a predetermined angle with respect to the longitudinal extent of the rear bodywork.

25. The rear bodywork according to claim 20, wherein the at least one air guiding element has a decreasing cross section.

26. The rear bodywork according to claim 15, wherein at least one air-permeable grid is arranged on or in the corresponding recess.

27. The rear bodywork according to claim 15, wherein at least one subsequent guiding element for the air flow is arranged on the corresponding flow channel.

28. A single-track motor vehicle comprising a rear wheel and a rear bodywork according to claim 15, wherein the corresponding flow channel is configured in such a manner that the air flow can be directed into a region between the rear wheel and the rear bodywork.
